(19) United States
(12) Patent Application Publication
(10) Pub. No.: US 2024/0330480 A1
(43) Pub. Date: Oct. 3, 2024

(54) SYSTEM AND METHOD FOR TRIAGING VULNERABILITIES BY APPLYING BUG REPORTS TO A LARGE LANGUAGE MODEL (LLM)

(71) Applicant: Cisco Technology, Inc., San Jose, CA (US)

(72) Inventor: Michael Roytman, Swannanoa, NC (US)

(21) Appl. No.: 18/356,178

(22) Filed: Jul. 20, 2023

Related U.S. Application Data
(60) Provisional application No. 63/493,552, filed on Mar. 31, 2023.

(51) Int. Cl. G06F 21/57; G06F 21/56

(52) U.S. Cl. CPC G06F 21/577; G06F 21/563

(57) ABSTRACT

A system and method are provided for predicting risks related to software vulnerabilities and thereby triaging said vulnerabilities. Input data (e.g., bug reports) are applied to a prediction engine (e.g., a machine learning (ML) method such as a large language model, a transformer neural network, or a classifier model), which outputs two or more scores for each vulnerability. A first score represents a likelihood of an exploit being developed (a threat), a second score represents a likelihood of being attacked (a greater threat), and a third score represents a likelihood of becoming a published common vulnerability and exposure (an even greater threat). Based on these scores, the vulnerabilities are triaged. Because the prediction engine is trained to make predictions using the unstructured data in bug reports, the vulnerabilities can be triaged soon after discovery, reducing the time to remediate vulnerabilities predicted to be significant threats.

### CROSS-REFERENCE TO RELATED APPLICATIONS

This application claims the benefit of priority to U.S. provisional application No. 63/493,552, filed on Mar. 31, 2023, which is expressly incorporated by reference herein in its entirety.

### BACKGROUND

A software bug is an error or fault in the design, development, or operation of computer software that causes it to produce an incorrect or unexpected result, or to behave in unintended ways. Software can include firmware, operating systems, applications, and programs. Some software bugs present vulnerabilities (e.g., weaknesses or flaws in computational logic) that can be exploited by bad actors. When exploited, a vulnerability can, e.g., facilitate unauthorized access to a computing device, enable an attack to remain undetected, permit unauthorized modification of data, reduce the availability of data. An attack of a software vulnerability is an attempt to exploit or take advantage of a vulnerability.

Vulnerabilities can be remediated using patches of version upgrades, for example. Due to resource constraints, how-ever, not all vulnerabilities can be remediated at the same time. Thus, remediation of vulnerabilities is typically prioritized according to different levels of risk posed by the respective vulnerabilities. For example, some vulnerabilities may never have exploits developed for them, and some exploits may never be used in an attack. Accordingly, remediation can be prioritized in the order of perceived risk. Thus, improved methods for determining the risk posed by vulnerabilities is desired to better deploy the limited resources for remediating vulnerabilities.

Because not all bugs are vulnerabilities, not all vulnerabilities can be exploited, and not all vulnerabilities that can be exploited are actually exploited, a hierarchy can be used for triaging and remediating known bugs. Additionally, waiting to remediate a vulnerability until an exploit is developed or until the vulnerability is attacked can be risky because significant harm can occur during the time in which a response is being developed. Waiting for exploits to be developed and for attacks to occur exposes computing assets to a significant amount of risk. Thus, in determining he risk posed by respective vulnerabilities, it is desirable to predict whether an exploit will be developed for particular vulnerabilities, and, if so, whether the exploits are likely to be used in an attack. This predicting and sorting of vulnerabilities is challenging. Accordingly, improved methods of predicting and sorting of known vulnerabilities are desired.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram for an example of a system/device for predicting scores and/or explanations corresponding to bug reports of vulnerabilities, in accordance with certain embodiments.

FIG. 2 illustrates a flow diagram for an example of a method of predicting scores and/or explanations corresponding to bug reports of vulnerabilities, in accordance with certain embodiments.

FIG. 3 illustrates a block diagram for database storing information related to attack modes of vulnerabilities, in accordance with certain embodiments.

FIG. 4A illustrates a block diagram for an example of a transformer neural network architecture, in accordance with certain embodiments.

FIG. 4B illustrates a block diagram for an example of an encoder of the transformer neural network architecture, in accordance with certain embodiments.

FIG. 4C illustrates a block diagram for an example of a decoder of the transformer neural network architecture, in accordance with certain embodiments.

FIG. 5A illustrates a flow diagram for an example of a method of training a neural network, in accordance with certain embodiments.

FIG. 5B illustrates a flow diagram for an example of a method of using the trained neural network, in accordance with certain embodiments.

FIG. 6 illustrates a block diagram for an example of a computing device, in accordance with certain embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In one aspect, a method is provided for applying input data to a prediction engine. The input data includes one or more bug reports of a first vulnerability. The one or more bug reports include prose that is unstructured data. The method further includes generating output data in response to the input data being applied to the prediction engine. The output data includes two or more scores including a value for a first score and a value for a second score, the first score representing a likelihood of an exploit being developed for the first vulnerability and the second score representing a likelihood the first vulnerability will be attacked using said exploit. The method further includes triaging the first vulnerability with respect to other vulnerabilities using the two or more scores.

In another aspect, the method may also include generating, as part of the output data resulting from applying the input data being applied to the prediction engine, a third score representing a likelihood the first vulnerability will become a common vulnerability and exposure (CVE); and triaging the first vulnerability with respect to other vulnerabilities using the first score, the second score, and the third score.

In another aspect, the method may also include signaling the two or more scores to a user; receiving user feedback regarding the two or more scores; and performing reinforcement learning based on the received user feedback to update the prediction engine.

In another aspect, the method may also include that the prediction engine is trained to classify the first vulnerability based on similarities of the first vulnerability to training vulnerabilities, wherein a set of training data used train the prediction engine comprises training bug reports and the training vulnerabilities, and, in the set of training data, each of the training vulnerabilities being associated with respective of the training bug reports. The prediction engine has been trained to learn patterns in the training bug reports and the similarities are based, in part, on a degree to which the one or more bug reports matches the learn patterned, wherein the first score and the second score of the first vulnerability are determined to be more like a subset of the training vulnerabilities for which the corresponding training bug reports has learned patterns that match the one or more bug reports to a greater degree.

In another aspect, the method may also include that the prediction engine comprises one or more machine learning (ML) methods, the one or more ML methods selected from the group consisting of: a transformer neural network, a natural language processing method, a named entity recognition keyword extraction method, a text classification neural network, and a tokenization neural network.

In another aspect, the method may also include that, in addition to the unstructured data of the one or more bug reports, the input data further comprises structured data including metadata. The prediction engine generates first predictive information by applying the structured data to a first ML method. The prediction engine generates second predictive information by applying the unstructured data to a second ML method comprising a transformer neural network. The two or more scores are generated based on the first predictive information and the second predictive information.

In another aspect, the method may also include that the prediction engine comprises a first ML method that generates the first score and a second ML method that generates the second score.

In another aspect, the method may also include that the second ML method uses the first score as an input to generate an output comprising the second score.

In another aspect, the method may also include applying another input data to the prediction engine, the another input data comprising another bug report of a second vulnerability, and in response generating the output data comprising another two or more scores including another value of the first score and another value of the second score. The method further may also include triaging the second vulnerability with respect to the first vulnerability using the two or more scores and the another two or more scores, such that: based on their respective values for the second score, the second score are assigned to bins that correspond to respective ranges of values of the second score; whichever of the first vulnerability and the second vulnerability is assigned to a bin that corresponds to a higher value for the second score is triaged to be remediated before the other; and when the first vulnerability and the second vulnerability are assigned to a same bin, then whichever of the first vulnerability and the second vulnerability has a higher value for the first score is triaged to be remediated before the other.

In another aspect, the method may also include applying another input data to the prediction engine, the another input data comprising another bug report of a second vulnerability, and in response generating the output data comprising another two or more scores including another value of the first score and another value of the second score. The method further may also include triaging the second vulnerability with respect to the first vulnerability using the two or more scores and the another two or more scores, such that the second score serves a primary role and the first score serves a secondary role in determining an order in which the second vulnerability is triaged with respect to the first vulnerability

In another aspect, the method may also include applying the input data to the prediction engine further generates the output data comprising explanations of an attack mode for the vulnerability. The explanations include information selected from the group consisting of tactics information, techniques information, procedures information, access vector information, attack complexity information, authentication information, confidentiality information; integrity information, and availability information.

In another aspect, the method may also include applying another input data to the prediction engine, the another input data comprising another bug report of a second vulnerability, and in response generating the output data comprising another two or more scores including another value of the first score, another value of the second score, and another value of the third score; and triaging the second vulnerability with respect to the first vulnerability using the two or more scores and the another two or more scores, such that the third score serves a primary role, the second score serves a secondary role and the first score serves a tertiary role in determining an order in which the second vulnerability is triaged with respect to the first vulnerability.

In one aspect, a computing apparatus includes a processor. The computing apparatus also includes a memory storing instructions that, when executed by the processor, configure the apparatus to perform the respective steps of any one of the aspects of the above recited methods.

In one aspect, a computing apparatus includes a processor. The computing apparatus also includes a memory storing instructions that, when executed by the processor, configure the apparatus to apply input data to a prediction engine, the input data comprising one or more bug reports of a first vulnerability, wherein the one or more bug reports comprise prose that is unstructured data. When executed by the processor, the stored instructions further configure the apparatus to generate output data in response to the input data being applied to the prediction engine. The output data includes two or more scores including a value for a first score and a value for a second score, the first score representing a likelihood of an exploit being developed for the first vulnerability and the second score representing a likelihood the first vulnerability will be attacked using said exploit. When executed by the processor, the stored instructions further configure the apparatus to triage the first vulnerability with respect to other vulnerabilities using the two or more scores.

In another aspect, when executed by the processor, instructions stored in the memory cause the processor to generate, as part of the output data resulting from applying the input data being applied to the prediction engine, a third score representing a likelihood the first vulnerability will become a common vulnerability and exposure (CVE); and triage the first vulnerability with respect to other vulnerabilities using the first score, the second score, and the third score.

In another aspect, when executed by the processor, instructions stored in the memory cause the processor to signal the two or more scores to a user; receive user feedback regarding the two or more scores; and perform reinforcement learning based on the received user feedback to generate updated coefficients for the prediction engine.

In another aspect, the prediction engine is trained to classify the first vulnerability based on similarities of the first vulnerability to training vulnerabilities, wherein a set of training data used train the prediction engine comprises training bug reports and the training vulnerabilities, and, in the set of training data, each of the training vulnerabilities being associated with respective of the training bug reports. The prediction engine has been trained to learn patterns in the training bug reports and the similarities are based, in part, on a degree to which the one or more bug reports matches the learn patterned, wherein the first score and the second score of the first vulnerability are determined to be more like a subset of the training vulnerabilities for which the corresponding training bug reports has learned patterns that match the one or more bug reports to a greater degree.

In another aspect, the prediction engine comprises one or more machine learning (ML) methods, the one or more ML methods selected from the group consisting of: a transformer neural network, a natural language processing method, a named entity recognition keyword extraction method, a text classification neural network, and a tokenization neural network.

In another aspect, in addition to the unstructured data of the one or more bug reports, the input data further comprises structured data. The prediction engine generates first predictive information by applying the structured data to a first machine learning (ML) method. The prediction engine generates second predictive information by applying the unstructured data to a second ML method comprising a transformer neural network. The two or more scores are generated based on the first predictive information and the second predictive information.

In another aspect, the prediction engine comprises a first machine learning (ML) method that generates the first score and a second ML method that generates the second score.

In another aspect, the second ML method uses the first score as an input to generate an output comprising the second score.

In another aspect, when executed by the processor, instructions stored in the memory cause the processor to apply another input data to the prediction engine, the another input data comprising another bug report of a second vulnerability, and in response generating the output data comprising another two or more scores including another value of the first score and another value of the second score. When executed by the processor, the stored instructions further configure the apparatus to triage the second vulnerability with respect to the first vulnerability using the two or more scores and the another two or more scores, such that: based on their respective values for the second score, the second score are assigned to bins that correspond to respective ranges of values of the second score; whichever of the first vulnerability and the second vulnerability is assigned to a bin that corresponds to a higher value for the second score is triaged to be remediated before the other; and when the first vulnerability and the second vulnerability are assigned to a same bin, then whichever of the first vulnerability and the second vulnerability has a higher value for the first score is triaged to be remediated before the other.

In another aspect, when executed by the processor, instructions stored in the memory cause the processor to apply another input data to the prediction engine, the another input data comprising another bug report of a second vulnerability, and in response generating the output data comprising another two or more scores including another value of the first score and another value of the second score. When executed by the processor, the stored instructions further configure the apparatus to triage the second vulnerability with respect to the first vulnerability using the two or more scores and the another two or more scores, such that the second score serves a primary role and the first score serves a secondary role in determining an order in which the second vulnerability is triaged with respect to the first vulnerability

In another aspect, when executed by the processor, instructions stored in the memory cause the processor to generate the output data in response to applying the input data to the prediction engine such that the output data further comprises explanations of an attack mode for the vulnerability. The explanations of the first vulnerability include information selected from the group consisting of tactics information, techniques information, procedures information, access vector information, attack complexity information, authentication information, confidentiality information; integrity information, and availability information.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improved methods of predicting and triaging of software vulnerabilities.

Software vulnerabilities are weaknesses or flaws in computational logic. When exploited, a vulnerability can be used in various malicious manners, including, e.g., facilitating unauthorized access to a computing device, enabling an attack to remain undetected, permitting unauthorized modification of data, or reducing the availability of data. An attempt to exploit or take advantage of a vulnerability is an attack, and a successful attack results in a breach.

Often, software programs are developed to exploit vulnerabilities. Herein, such software programs are referred to as “exploits.” Vulnerabilities can be fixed using patches or version upgrades, for example. Limited resources result in triaging vulnerabilities to allocate resources in a way that prioritize remediation of those vulnerabilities believed to be the greatest threats.

Although many software vulnerabilities are reported, only a subset of these reported vulnerabilities will have exploits developed for them, and of these a still smaller subset of the vulnerabilities will be attacked using the developed exploits. Being able to predict which vulnerabilities are likely to have exploits developed and which are likely to be attacked would enable security professionals to timely and efficiently preempt attacks by starting to remediate high-risk vulnerabilities early, even before exploits are developed and/or used in attacks.

The methods and systems disclosed herein that implement said methods enable efficiently triaging and remediating vulnerabilities by predicting scores corresponding to likelihoods that exploits will be developed for the vulnerabilities and by predicting scores corresponding to likelihoods that the vulnerabilities will be attacked using the exploits. These scores enable prioritizing early remediation of the vulnerabilities that pose the greatest security risks. Further, the methods disclosed herein enable assessing the risks presented by vulnerabilities early in the process because said assessment can be based on bug reports without requiring additional data from testing and further investigation of the vulnerabilities. Thus, the methods disclosed herein have the advantage of providing scores for nascent vulnerabilities because the scores are generated based on bug reports. The scores provide guidance to security professionals for decisions related to prioritizing the respective vulnerabilities for additional testing and further investigation of the vulnerabilities.

Remediating vulnerabilities can be prioritized according to different levels of risk posed by the respective vulnerabilities. For example, some vulnerabilities may never have exploits developed for them, and some exploits may never be used in an attack. Further, some vulnerabilities may be attacked but still not rise to a level of significance that they are recognized as a common vulnerability and exposure (CVE) that becomes published. Accordingly, remediating vulnerabilities can be prioritized in the following order:
1. vulnerabilities that become CVEs and are published,
2. vulnerabilities having exploits that have been used in attacks,
3. vulnerabilities that are likely to become CVEs and be published,
4. vulnerabilities that are likely to be attacked but are not likely to become published CVEs,
5. vulnerabilities having exploits but the exploits are not likely to be used in attacks,
6. vulnerabilities for which exploits are likely to be developed but not likely to be used in attacks, and
7. vulnerabilities not having any exploits and for which exploits are not likely to be developed.

Generally, CVEs pose the greatest risk, and attacks on vulnerabilities pose a greater risk than an exploit that has been developed but not used in an attack. Actual CVEs can be prioritized over predicted CVEs. Further, actual attacks can be prioritized over predicted attacks, and actual exploits can be prioritized over predicted exploits. For example, when triaging vulnerabilities based on predictions, the order in which vulnerabilities are triaged can consider first as a primary matter the likelihood of the vulnerabilities being attacked, and then, for vulnerabilities with a similar likelihood of being attacked, the likelihood of exploits being developed can be considered as a secondary matter (e.g., as a tie breaker).

For example, when a first score represents the likelihood of an exploit being developed for a vulnerability, a second score represents the likelihood of a vulnerability being attacked, and a third score represents the likelihood of the vulnerability becoming a published CVE, a composite score can be generated using a weighted sum of the three scores in which the third score is weighted the most and the second score as weighted more than the first score, making the third score primary and the second score secondary and the first score tertiary in level of importance and effect on prioritizing the vulnerabilities.

The three scores make up a hierarchy of threats with the third score being the greatest threat because vulnerabilities become CVEs when the attacks pose a significant risk to merit the effort of publishing the vulnerability as a CVE. Thus, not all vulnerabilities that are attacked rise to the threat level of a published CVE. The next level in the hierarchy of threats is the second score, which represents the likelihood of vulnerabilities being attacked. And the lowest level of the hierarchy of threats is the first score, which represents the likelihood of an exploit being developed of the vulnerabilities. This is because vulnerabilities that are attacked but are not CVEs pose a greater threat/risk than vulnerabilities that are not attacked but for which an exploit is developed.

The determination and application of the scores is illustrated at points using only the first and second scores. But all discussions on the first and second scores straightforwardly generalize to three or more scores. Thus, the disclosure of systems and methods using the first score and the second score are not limiting, but these disclosures of systems and methods that are illustrated for two scores can scale up to three scores. That is, all disclosures of systems and methods herein apply to three scores. Further, the disclosure of systems and methods herein apply to more than three scores.

The vulnerabilities could be organized into bins representing respective ranges of values for the second score. Then, within a given bin, vulnerabilities are arranged in accordance with the first score. Again, the second score would be the primary consideration (e.g., the first consideration) when triaging the vulnerabilities and the first score would be the secondary consideration (e.g., the second consideration) for determining the order in which to remediate the vulnerabilities.

The vulnerabilities can be organized into large bins representing respective ranges of values for the third score. Then, within each large bin, the vulnerabilities can be organized into small bins representing respective ranges of values for the second score. Then, within a given small bin, vulnerabilities are arranged in accordance with the first score. Here, the third score would be the primary consideration (e.g., the first consideration) when triaging the vulnerabilities, and the second score would be the secondary consideration (e.g., the first consideration) when triaging the vulnerabilities. The first score would be the tertiary consideration (e.g., the second consideration) for determining the order in which to remediate the vulnerabilities.

The methods disclosed herein can use machine learning (ML) methods to predict the likelihoods of exploits and attacks for vulnerabilities. According to certain non-limiting examples, these predictions use ML methods that are trained to learn patterns in bug reports for respective vulnerabilities, and these patterns in the bug reports are predictive of whether exploits will be developed for the respective vulnerabilities and whether the exploits, once developed, will be used in attacks.

For example, the ML methods can use the similarity of new bug report(s) for a current vulnerability to prior bug reports in a historical database of older vulnerabilities to predict that the current vulnerability will follow a similar trajectory to those older vulnerabilities for which the new bug report(s) have a high degree of similarity to the corresponding bug reports in the historical database.

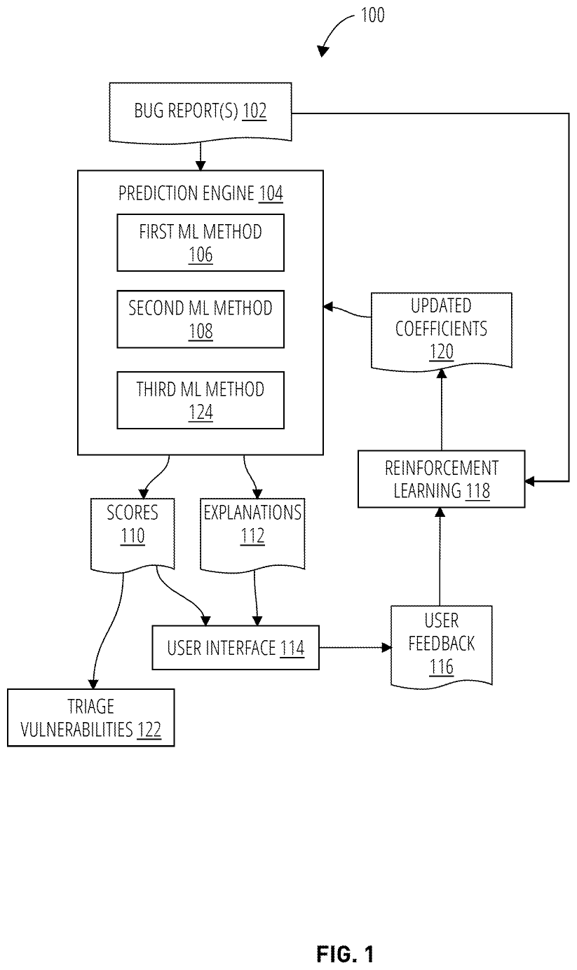

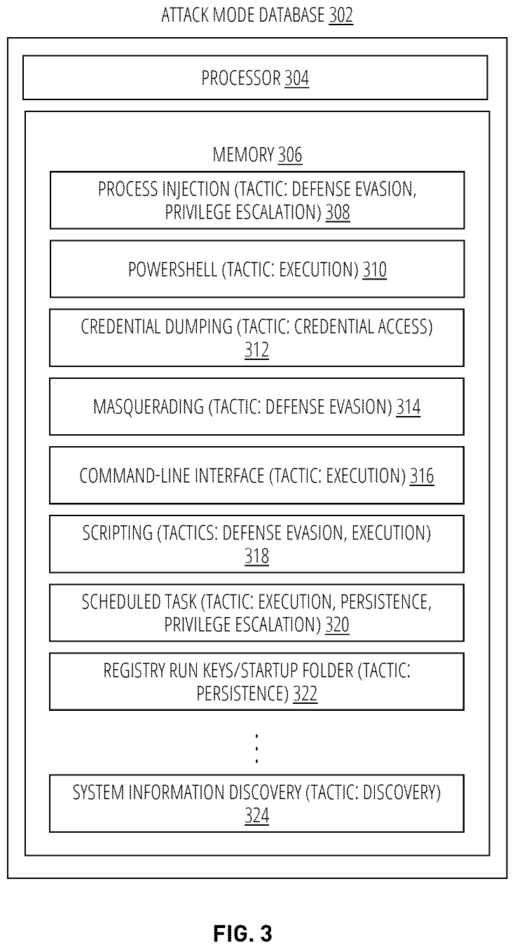

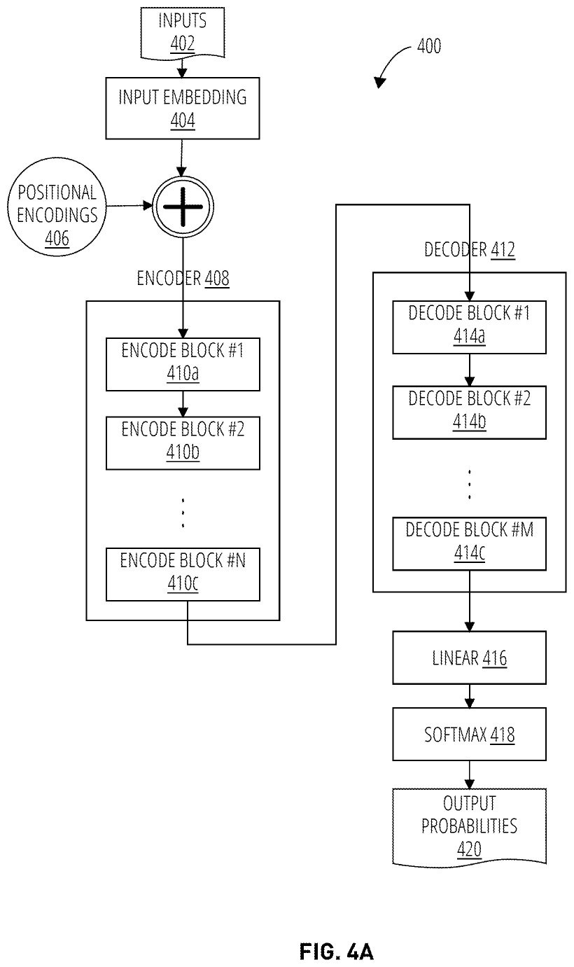

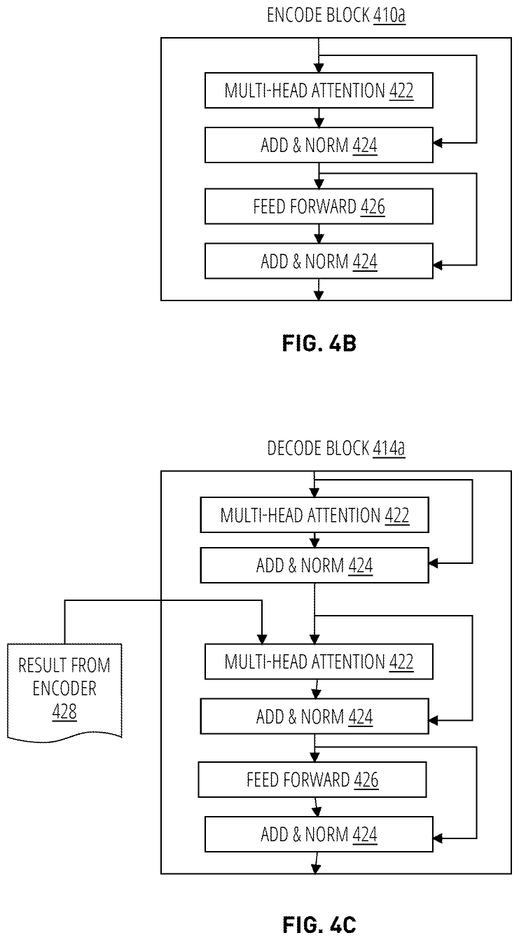

The prediction and triage system 100 shown in FIG. 1 includes a prediction engine 104 that receives data describing a vulnerability (e.g., the bug report(s) 102). The prediction engine 104 can include one or more machine learning (ML) methods. The prediction engine 104 is illustrated in FIG. 1 as having two ML methods: a first ML method 106, a second ML method 108. and a third ML method 124. The prediction engine 104 generates several outputs, which can include the scores 110 and the explanations 112. Aspects of the prediction engine 104 and the ML methods used therein are described below with reference to FIG. 3 and the transformer architecture 400 illustrated in FIGS. 4A-4C.

The scores 110 from the prediction engine 104 can be used in two ways: (i) the scores can be communicated via a user interface 114 to a user and (ii) the scores can be used to triage vulnerabilities 122. When the scores 110 are used for the triage vulnerabilities 122, the scores 110 are used to set an order in which the respective vulnerabilities are remediated.

The prediction and triage system 100 includes a user interface 114 that can display the output data to a user and can receive user feedback 116 from the user. For example, the user can confirm the correctness of the output data/predictions from the prediction engine 104, or the user can provide corrections to the output data/predictions from the prediction engine 104. The user feedback 116 is then combined with the bug report(s) 102 as new training data to be used in reinforcement learning 118 to generate updated coefficients 120 for the ML methods in the prediction engine 104.

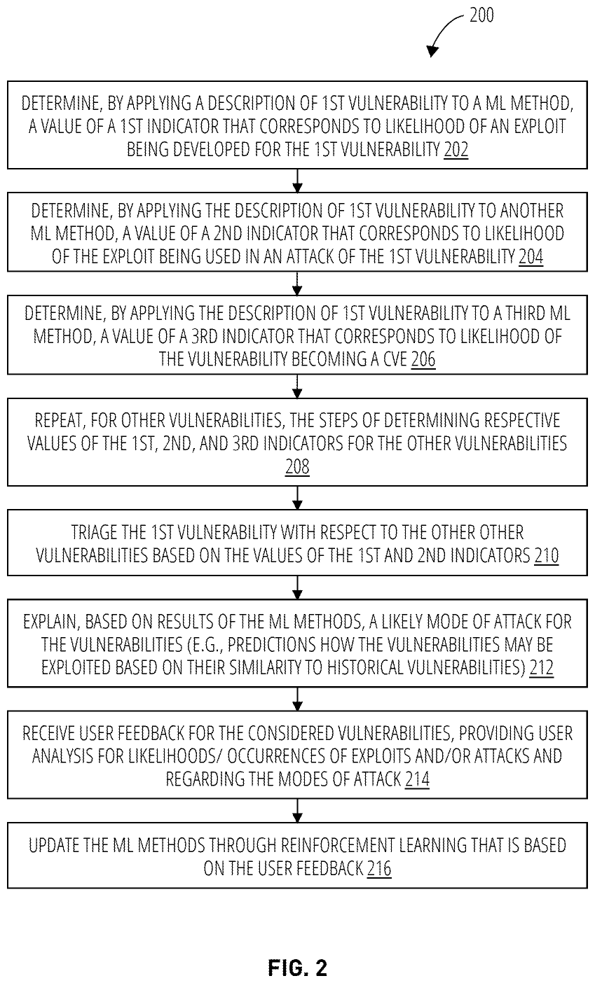

FIG. 2 illustrates an example prediction method 200 for predicting which vulnerabilities will have exploits developed for and which vulnerabilities will be attacked using said exploits. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, step 202 of the prediction method 200 includes applying a description of first vulnerability (e.g., bug report(s) 102) to a first ML method (e.g., first ML method 106) to determine a value of a first indicator (e.g., one of the scores 110) that corresponds to likelihood of an exploit being developed for the first vulnerability.

According to some examples, step 204 of the prediction method 200 includes applying the description of first vulnerability (e.g., bug report(s) 102) to another ML method (e.g., second ML method 108) to determine a value of a second indicator (e.g., another one of the scores 110) that corresponds to likelihood of the exploit being used in an attack of the first vulnerability.

According to some examples, step 206 of the prediction method 200 includes applying the description of first vulnerability (e.g., bug report(s) 102) to a third ML method and thereby to determine a 3rd indicator that corresponds to likelihood of the vulnerability becoming a published CVE.

There is a significant amount of unstructured data that has hitherto not been used for predictions regarding which vulnerabilities will be attacked and for predictions regarding which vulnerabilities exploits will be developed. Steps 202, 204, and 206 use this unstructured data to assess the likelihood of vulnerabilities having exploits developed and the likelihood of these exploits being used for cyber attacks and becoming published CVEs. In certain implementations, steps 202, 204, and 206 can also use the structured data (e.g., metadata in bug reports) together with the unstructured data (e.g., prose in the bug reports) for these predictions.

For example, historical data regarding vulnerabilities such as the Product Security Incident Response Team (PSIRT) Advanced Security Initiatives Group (ASIG) data can be used label bug reports that is used training data to train a large language model (LLM). Thus, the LLM can be trained to distinguish between vulnerabilities that are likely to become common vulnerabilities and exposures (CVE) versus those that are not.

In certain non-limiting examples, the ML methods can be trained using a set of training data that includes a large corpus of bug reports spanning many years (e.g., 20 years) that includes previous vulnerabilities that both did and did not become CVEs. As different vendors have stylistically different bug reports, the training data can include a field indicating a source/vendor for the bug report. Thus, the coefficients and weights in the ML method can depend on the source/vendor field. Additionally, the ML methods can be trained to account for which specific certified numbering authority (CNA) generated the bug report. The ML methods can be trained to predict which vulnerabilities are likely to become CVEs in the future.

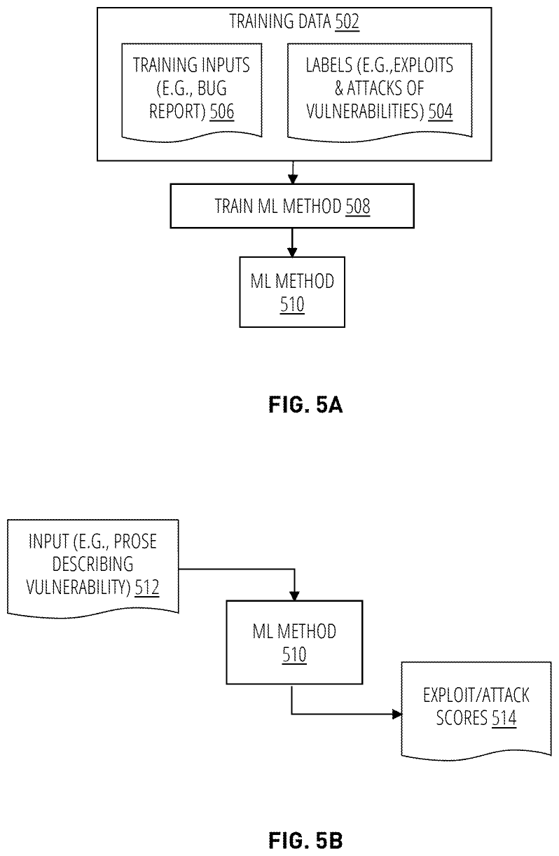

Generally, the ML methods can be trained for any software vendor by using that software vendor's corpus of bug reports. Bug reports can include both structured data (e.g., metadata) and unstructured data (e.g., the text describing the vulnerability conveyed in prose). The term “prose” is understood herein to mean “the ordinary language people use in speaking or writing.” Bug reports can include, but are not limited to, JIRA tickets and SERVICENOW tickets. As discussed below with reference to FIG. 5A, based on the provided training data, the ML methods can be trained to classify future bugs based on their similarity with prior bug reports and thereby determine which of those are candidates to become exploited vulnerabilities and which of those are just noise in a backlog of bug reports.

In certain non-limiting examples, the ML methods can include a transformer architecture 400, as discussed below with reference to FIGS. 4A-4C. The transformer architecture 400 has several advantages including an ability to process unstructured data, such as prose. According to one example, bug reports offer a large amount of structured data (e.g., metadata) and unstructured data (text data from the report). A transformer neural network (e.g., an LLM) can process the text and other data of the bug and determines how likely that bug is to become a vulnerability in the future, and, if it became a vulnerability, the transformer architecture 400 can predict how widespread would the vulnerability be. The LLM would be trained, e.g., to assess how closely the bug (vulnerability) looks like other vulnerabilities. If the bug looks like other vulnerabilities that a given entity has published in the past and the metadata from that publication means that multiple advisories will pick it up, then it is likely that multiple Computer Emergency Readiness Teams (CERTs) will care about if an exploit will come out. The LLM can output similarity coefficients that is a quantitative measure representing the similarity to prior CVEs, and such a coefficient gives the CERTs guidance as to which bugs they should prioritize for vulnerability research.

Steps 202, 204, and 206 provide a non-limiting example for how the scores 110 can be generated by one or more ML methods. In this example, three ML methods are used to generate three scores. The first ML methods 106, the second ML methods 108, and third ML method 124 can be performed in series or in parallel. According to certain non-limiting examples, the first indicator/score from the first ML methods 106 can be used as an input for the second ML methods 108 because the exploit being used in attack depends on the exploit first being developed, and therefore the second indicator/score can depend on the first indicator/score (e.g. the second indicator/score is less than or equal to the first indicator/score).

Alternatively, a single ML method could be used to generate all scores. Additionally or alternatively, in the prediction engine 104, the ML methods can be combined in various configurations with other methods to provide the scores 110 and the explanations 112.

According to some examples, step 208 of the prediction method 200 includes repeating, for other vulnerabilities, the steps of determining respective values of the first and second indicators/scores for the other vulnerabilities.

According to some examples, step 210 of the prediction method 200 includes triaging the first vulnerability with respect to the other other vulnerabilities based on the values of the first and second indicators at step 210. For example, the two or three scores can be combined into a composite score using a weighted sum. Generally being attacked presents a greater risk than having an exploit developed. Therefore, the second score can be weighted more than the first score because the second score represents the likelihood of a vulnerability being attacked, whereas the first score represents the likelihood of an exploit being developed for a vulnerability.

Actual attacks can be prioritized over predicted attacks, and actual exploits can be prioritized over predicted exploits. For example, when triaging vulnerabilities based on predictions, the order in which vulnerabilities are triaged can consider first as a primary matter the likelihood of the vulnerabilities being attacked (for actual attacks this likelihood is 100%), and then, for vulnerabilities with a similar likelihood of being attacked, the likelihood of exploits being developed can be considered as a secondary matter (e.g., as a tie breaker).

In certain non-limiting examples, triaging can also account for the danger posed by a successful attack. For example, the common vulnerability scoring system (CVSS) discussed below includes values for confidentiality, availability, and integrity, which can be values included in the explanations 112, as discussed below. Predictions for these values can provide guidance regarding the danger posed by a successful attack. A confidentiality value represents how much sensitive data an attacker can access after exploiting the vulnerability. An integrity value represents how much and how many files can be modified as a result of exploiting the vulnerability. An availability value represents how much damage exploiting the vulnerability does to the target system.

In another example, the vulnerabilities could be organized into bins representing respective ranges of values for the second score. Then, within a given bin, vulnerabilities are arranged in accordance with the first score. Again, the second score would be the primary consideration (e.g., the first consideration) when triaging the vulnerabilities and the first score would be the secondary consideration (e.g., the second consideration) for determining the order in which to remediate the vulnerabilities.

Triaging two vulnerabilities (e.g., a first vulnerability and a second vulnerability) can include that the two vulnerabilities are assigned to bins that correspond to respective ranges for the second score. For example, if the second score is constrained to values between zero and one, then 19 bins can be defined in increments of 0.05. Then, whichever of the first vulnerability and the second vulnerability is assigned to a bin that corresponds to a higher value for the second score is triaged to be remediated before the other. In the case that the first vulnerability and the second vulnerability are assigned to a same bin, then whichever of the first vulnerability and the second vulnerability has a higher value for the first score is triaged to be remediated before the other.

Alternatively, triaging the second vulnerability with respect to the first vulnerability can be realized using the first score and the second score, such that the second score serves a primary role and the first score serves a secondary role in determining an order in which the second vulnerability is triaged with respect to the first vulnerability.

According to some examples, step 212 of the prediction method 200 includes explaining, based on results of the ML methods, a likely mode of attack for the vulnerabilities (e.g., predictions how the vulnerabilities may be exploited based on their similarity to historical vulnerabilities).

According to some examples, step 212 of the prediction method 200 includes receiving user feedback 116 for the considered vulnerabilities, providing user analysis for likelihoods/occurrences of exploits and/or attacks and regarding the modes of attack at step 214. User feedback 116 can be generated in response to scores 110. Additionally, the user feedback 116 can occur after a security expert has had time to study the vulnerability and perform additional testing and analysis.

In certain non-limiting examples, the user feedback 116 can be crowd sourced. For example, the Exploit Prediction Scoring System (EPSS) is an open, data-driven effort for estimating the likelihood (probability) that a software vulnerability will be exploited. The scores 110 can be generated based on bug reports, and therefore the score can be generated much earlier than a value of the EPSS. But the EPSS can provide feedback that is used to label the bug reports, and the labeled bug reports are then used as training data for either reinforcement learning or for the initial training of the ML methods.

According to some examples, step 212 of the prediction method 200 includes updating the ML methods through reinforcement learning that is based on the user feedback at step 216.

The attack mode database 302 includes a processor 304, a memory 306 The memory includes several attack modes for vulnerabilities and associated information regarding the attack modes, such as the tactics, techniques, and procedures applicable to each of the given vulnerabilities. In the non-limiting example shown in FIG. 3, the attack modes include process injection 308, powershell 310, credential dumping 312, masquerading 314, command-line interface 316, scripting 318, scheduled task 320, registry run keys/startup folder 322, and system information discovery 324. The attack modes can be classifications. For example, the ML methods can generate probabilities that a given vulnerability is within one (or more) of these classifications.

In certain non-limiting examples, the attack modes can use the MITRE ATT&CK framework (e.g., 14 tactics, 185 techniques, 367 sub-techniques). For example, the known combinations of tactics and techniques can make up a tokenized vocabulary, and one or more of the ML methods in the prediction engine 104 can be a transformer neural network can translate from the prose description in a given bug report to the tokenized vocabulary of the MITRE ATT&CK framework. This translation can be based on similarities between the given bug report and historical bug reports for historical vulnerabilities that were used in the training data to train the transformer neural network.

Additionally or alternatively, the attack modes can corresponding to various metrics applied for common vulnerability scoring system (CVSS), including: (i) an access vector (e.g., the way in which a vulnerability can be exploited); (ii) attack complexity (e.g., how difficult a vulnerability is to exploit); (iii) authentication (e.g., how many times an attacker has to use authentication credentials to exploit the vulnerability); (iv) confidentiality (e.g., how much sensitive data an attacker can access after exploiting the vulnerability); (v) integrity (e.g., how much and how many files can be modified as a result of exploiting the vulnerability); and (vi) availability (e.g., how much damage exploiting the vulnerability does to the target system).

Additionally or alternatively, one or more of the ML methods in the prediction engine 104 can include a clustering method. A transformer neural network or natural language processing method can map the unstructured data to a multi-dimensional space representative of different aspects/dimensions of the vulnerability. This mapping from the prose description of the vulnerability to the multi-dimensional space can be a learned mapping. When the historical bug reports corresponding to the historical vulnerabilities are mapped to the multi-dimensional space, then a clustering method (e.g., such as k-means clustering) can be applied within the multi-dimensional space to group/divide different regions according to the attack classifications. The learned mapping provides the optimal clustering. When a bug reports for a given vulnerability is mapped to a given location the multi-dimensional space, then the probability corresponding to classifications can be related to in inverse of a distance measure (e.g., the Euclidean distance) with some normalization.

The similarity probabilities determined using the information in the unstructured data can be further modified and refined using additional information provided in structured data related to the vulnerability, such as metadata, source code, log files, etc. For example, a transformer neural network that is applied to the unstructured data (e.g., prose in a bug report that describes the vulnerability) can generate a first set of output data. Another ML method (e.g., another artificial neural network (ANN)) that is operating on the structured data can generate a second set of output data. Then the first set of output data can be combined with the second set of output data to provide inputs to a third ANN which uses the combined information from the structured and unstructured data to generate the scores 110 and the explanations 112.

The explanations 112 can include additional information to guide the cyber security professional. The additional information can include a mean and a standard deviation for a time period from when a vulnerability is reported until when an exploit is developed or when an attack first occurs. The additional information can include guidance on the probabilities of respective tactics, techniques, and procedures being applicable for a given vulnerability. The additional information can include guidance on the probabilities of certain values of the CVSS being applicable for a given vulnerability (e.g., the access vector, attack complexity, etc.).

Whether a MITRE ATT&CK framework, a CVSS, other heuristic for classifying vulnerabilities, or combination thereof is used to classify a given vulnerability, the classification information can be used to provide the scores 110 and the explanatory information (e.g., explanations 112) generated by the prediction engine. For example, the similarity of the bug report for the given vulnerability to historical bug reports indicates that the given vulnerability will have a probability of being attacked that is related to an average attack rate for the similar historical vulnerabilities. For example, a probability can be calculated by a weighted sum over the average attack likelihood of each of the similar classifications where the sum is weighted by the similarity to each of the similar classifications (e.g., the normalized percentage that the given vulnerability is part of the similar classification).

A person of ordinary skill in the art will recognize that the above examples are non-limiting and that, whiteout departing from the spirit of the disclosure and the contemplated invention, other methods and techniques of using the unstructured data in the prose of a bug report, which describes a given vulnerability, can be used to generate the scores 110 and the explanatory information (e.g., explanations 112).

The transformer architecture 400, which is illustrates in FIGS. 4A-4C, includes inputs 402, an input embedding block 404, positional encodings 406, an encoder 408 (e.g., encode blocks 410a, 410b, and 410c), a decoder 412 (e.g., decode blocks 414a, 414b, and 414c), a linear block 416, a softmax block 418, and an output probabilities 420.

The inputs 402 can include bug reports and other data conveying information about a vulnerability. The transformer architecture 400 is used to determine output probabilities 420 regarding the vulnerability, including, e.g., (i) whether an exploit is likely to be developed for vulnerability,

The input embedding block 404 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 404 can be learned embeddings to convert the input tokens and output tokens to vectors of dimension have the same dimension as the positional encodings, for example.

The positional encodings 406 provide information about the relative or absolute position of the tokens in the sequence. According to certain non-limiting examples, the positional encodings 406 can be provided by adding positional encodings to the input embeddings at the inputs to the encoder 408 and decoder 412. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that so doing allows the model to extrapolate to sequence lengths longer than the ones encountered during training.

The encoder 408 uses stacked self-attention and point-wise, fully connected layers. The encoder 408 can be a stack of N identical layers (e.g., N=6), and each layer is an encode block 410, as illustrated by encode block 410a shown in FIG. 4B. Each encode block 410 has two sub-layers: (i) a first sub-layer has a multi-head attention block 422 and (ii) a second sub-layer has a feed forward block 426, which can be a position-wise fully connected feed-forward network. The feed forward block 426 can use a rectified linear unit (ReLU).

The encoder 408 uses a residual connection around each of the two sub-layers, followed by an add & norm block 424, which performs normalization (e.g., the output of each sub-layer is LayerNorm(x+Sublayer(x)), i.e., the product of a layer normalization “LayerNorm” time the sum of the input “x” and output “Sublayer(x)” pf the sublayer LayerNorm(x+Sublayer(x)), where Sublayer(x) is the function implemented by the sub-layer). To facilitate these residual connections, all sub-layers in the model, as well as the embedding layers, produce output data having a same dimension.

Similar to the encoder 408, the decoder 412 uses stacked self-attention and point-wise, fully connected layers. The decoder 412 can also be a stack of M identical layers (e.g., M=6), and each layer is a decode block 414, as illustrated by encode decode block 414a shown in FIG. 4C. In addition to the two sub-layers (i.e., the sublayer with the multi-head attention block 422 and the sub-layer with the feed forward block 426) found in the encode block 410a, the decode block 414a can include a third sub-layer, which performs multi-head attention over the output of the encoder stack. Similar to the encoder 408, the decoder 412 uses residual connections around each of the sub-layers, followed by layer normalization. Additionally, the sub-layer with the multi-head attention block 422 can be modified in the decoder stack to prevent positions from attending to subsequent positions. This masking, combined with fact that the output embeddings are offset by one position, ensures that the predictions for position i can depend only on the known output data at positions less than i.

The linear block 416 can be a learned linear transformation. For example, when the transformer architecture 400 is being used to translate from a first language into a second language, the linear block 416 projects the output from the last decode block 414c into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

The softmax block 418 then turns the scores from the linear block 416 into output probabilities 420 (which add up to 1.0). In each position, the index provides for the word with the highest probability, and then map that index to the corresponding word in the vocabulary. Those words then form the output sequence of the transformer architecture 400. The softmax operation is applied to the output from the linear block 416 to convert the raw numbers into the output probabilities 420 (e.g., token probabilities).

Although the above example uses the case of translating from the first language to the second language to illustrate the functions of the transformer architecture 400, the output probabilities 420 can be other entities, such as probabilities regarding whether a vulnerability described by the inputs 402 will be attacked or have exploits developed for the vulnerability. Further, the predicted output probabilities 420 can relate to the attack mode/classification (e.g., using the MITRE ATT&CK framework). The transformer architecture 400 can generate output probabilities 420 related to the tactics, techniques, and procedures applicable to the vulnerability.

The transformer architecture 400 can generate output probabilities 420 related to predictions for the metrics applied for common vulnerability scoring system (CVSS), including, e.g. an access vector (e.g., the way in which a vulnerability can be exploited); attack complexity (e.g., how difficult a vulnerability is to exploit); authentication (e.g., how many times an attacker has to use authentication credentials to exploit the vulnerability); confidentiality (e.g., how much sensitive data an attacker can access after exploiting the vulnerability); integrity (e.g., how much and how many files can be modified as a result of exploiting the vulnerability); and availability (e.g., how much damage exploiting the vulnerability does to the target system).

The transformer architecture 400 can generate output probabilities 420 related to the explanatory information regarding that can guide cybersecurity professionals how the vulnerability operates, how it can be attacked, and how it might be remediated.

FIG. 5A illustrates an example of training an ML method 510 (e.g., the first ML method 106 or the second ML method 108). In step 508, training data 502, which includes the labels 504 and the training inputs 506) is applied to train the ML method 510. For example, the ML method 510 can be an artificial neural network (ANN) that is trained via supervised learning using a backpropagation technique to train the weighting parameters between nodes within respective layers of the ANN. In supervised learning, the training data 502 is applied as an input to the ML method 510, and an error/loss function is generated by comparing the output from the ML method 510 with the labels 504 (e.g., user feedback 116, which can include user supplied values for the scores 110). The coefficients of the ML method 510 are iteratively updated to reduce an error/loss function. The value of the error/loss function decreases as outputs from the ML method 510 increasingly approximate the labels 504. In other words, ANN infers the mapping implied by the training data, and the error/loss function produces an error value related to the mismatch between the labels 504 and the outputs from the ML method 510 that are produced as a result of applying the training inputs 506 to the ML method 510.

For example, in certain implementations, the cost function can use the mean-squared error to minimize the average squared error. In the case of a of multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using any of numerous algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribiére update, Powell-Beale restart, and scaled conjugate gradient). Additionally, evolutionary methods, such as gene expression programming, simulated annealing, expectation-maximization, non-parametric methods and particle swarm optimization, can also be used for training the ML method 510.

The training 508 of the ML method 510 can also include various techniques to prevent overfitting to the training data 502 and for validating the trained ML method 510. For example, boot strapping and random sampling of the training data 502 can be used during training.

In addition to supervised learning used to initially train the ML method 510, the ML method 510 can be continuously trained while being used by using reinforcement learning based on the network measurements and the corresponding configurations used on the network. The ML method 510 can be cloud based and can be trained using network measurements and the corresponding configurations from other networks that provide feedback to the cloud.

Further, other machine learning (ML) algorithms can be used for the ML method 510, and the ML method 510 is not limited to being an ANN. For example, there are many machine-learning models, and the ML method 510 can be based on machine learning systems that include generative adversarial networks (GANs) that are trained, for example, using pairs of network measurements and their corresponding optimized configurations.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 5B illustrates an example of using the trained ML method 510. The input data 512 are applied to the trained ML method 510 to generate the outputs, which can include the exploit/attack scores 514.

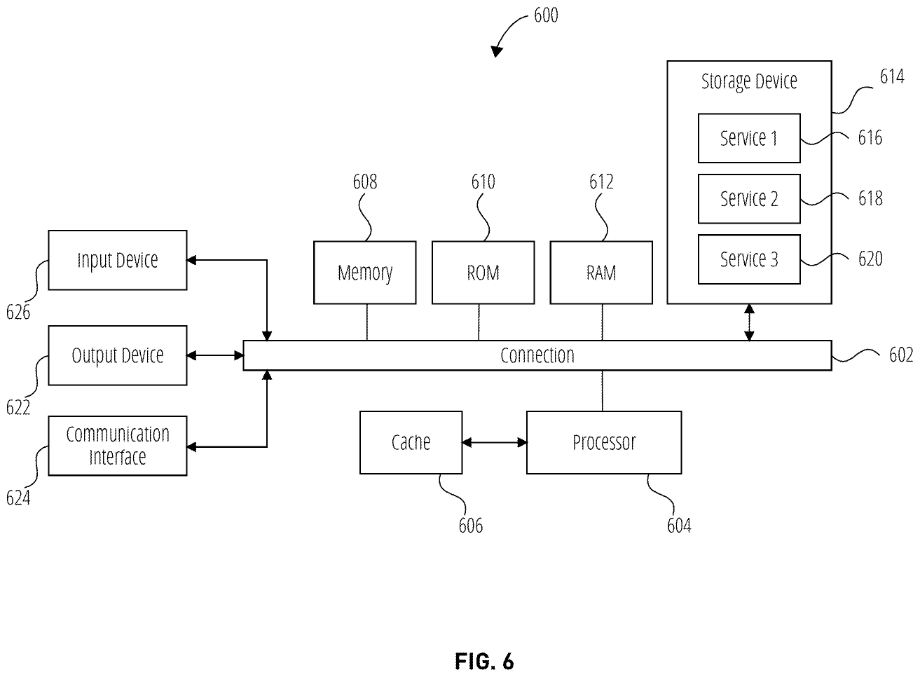

FIG. 6 shows an example of computing system 600, which can be for example any computing device configured to perform one or more of the steps of prediction method 200; any computing device making up the prediction and triage system 100; or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer. such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602. output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a prediction and triage system 100 and perform one or more functions of the prediction method 200 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of predicting risks related to software vulnerabilities, the method comprising:
applying input data to a prediction engine, the input data comprising one or more bug reports of a first vulnerability, wherein the one or more bug reports comprise prose that is unstructured data;
generating output data in response to the input data being applied to the prediction engine, the output data comprising two or more scores including a value for a first score and a value for a second score, the first score representing a likelihood of an exploit being developed for the first vulnerability and the second score representing a likelihood the first vulnerability will be attacked using said exploit; and
triaging the first vulnerability with respect to other vulnerabilities using the two or more scores.

2. The method of claim 1, further comprising:
generating, as part of the output data resulting from applying the input data being applied to the prediction engine, a third score representing a likelihood the first vulnerability will become a common vulnerability and exposure (CVE); and
triaging the first vulnerability with respect to other vulnerabilities using the first score, the second score, and the third score.

3. The method of claim 1, further comprising:
signaling the values of the two or more scores to a user;
receiving user feedback regarding the values of the two or more scores; and
performing reinforcement learning based on the received user feedback to update the prediction engine.

4. The method of claim 1, wherein:
the prediction engine is trained to classify the first vulnerability based on similarities of the first vulnerability to training vulnerabilities, wherein a set of training data used to train the prediction engine comprises training bug reports and the training vulnerabilities, and, in the set of training data, each of the training vulnerabilities is associated with a corresponding training bug report of the training bug reports.

5. The method of claim 4, wherein:
the prediction engine has been trained to learn patterns in the training bug reports and the similarities are based, in part, on a degree to which the one or more bug reports matches the learned patterns to determine from among the training vulnerabilities a subset of similar vulnerabilities from the training vulnerabilities;
the value of the first score of the first vulnerability are determined based on probabilities that exploits were developed for the subset of similar vulnerabilities; and
the value of the second score of the first vulnerability are determined based on probabilities that the exploits were used to attack the subset of similar vulnerabilities.

6. The method of claim 1, wherein the prediction engine comprises one or more machine learning (ML) methods, the one or more ML methods selected from the group consisting of: a transformer neural network, a natural language processing method, a named entity recognition keyword extraction method, a text classification neural network, and a tokenization neural network.

7. The method of claim 1, wherein:
in addition to the unstructured data of the one or more bug reports, the input data further comprises structured data including metadata;
the prediction engine generates first predictive information by applying the structured data to a first ML method;
the prediction engine generates second predictive information by applying the unstructured data to a second ML method comprising a transformer neural network; and
the two or more scores are generated based on the first predictive information and the second predictive information.

8. The method of claim 1, wherein:
the prediction engine comprises a first ML method that generates the first score;
the prediction engine comprises a second ML method that generates the second score; and
the second ML method uses the first score as an input to generate an output comprising the second score.

9. The method of claim 1, further comprising:
applying another input data to the prediction engine, the another input data comprising another bug report of a second vulnerability, and in response generating the output data comprising another two or more scores including another value of the first score and another value of the second score; and
triaging the second vulnerability with respect to the first vulnerability using the values of the two or more scores and using the another values of the two or more scores, such that:
based on the values and the another value for the second score, the second score are assigned to bins that correspond to respective ranges for the second score;
whichever of the first vulnerability and the second vulnerability is assigned to a bin that corresponds to a higher value for the second score is triaged to be remediated before the other; and
when the first vulnerability and the second vulnerability are assigned to a same bin, then whichever of the first vulnerability and the second vulnerability has a higher value for the first score is triaged to be remediated before the other.

10. The method of claim 1, further comprising:
applying another input data to the prediction engine, the another input data comprising another bug report of a second vulnerability, and in response generating the output data comprising another two or more scores including another value of the first score and another value of the second score; and
triaging the second vulnerability with respect to the first vulnerability using the two or more scores and the another two or more scores, such that the second score serves a primary role and the first score serves a secondary role in determining an order in which the second vulnerability is triaged with respect to the first vulnerability.

11. The method of claim 2, further comprising:
applying another input data to the prediction engine, the another input data comprising another bug report of a second vulnerability, and in response generating the output data comprising another two or more scores including another value of the first score, another value of the second score, and another value of the third score; and
triaging the second vulnerability with respect to the first vulnerability using the two or more scores and the another two or more scores, such that the third score serves a primary role, the second score serves a secondary role and the first score serves a tertiary role in determining an order in which the second vulnerability is triaged with respect to the first vulnerability.

12. The method of claim 1, wherein:
applying the input data to the prediction engine further generates the output data comprising explanations of an attack mode for the vulnerability, wherein
the explanations include information selected from the group consisting of tactics information, techniques information, procedures information, access vector information, attack complexity information, authentication information, confidentiality information;
integrity information, and availability information.

13. A computing apparatus for predictions related to vulnerabilities, the computing apparatus comprising:
a processor; and
a memory storing instructions that, when executed by the processor, configure the apparatus to:
apply input data to a prediction engine, the input data comprising one or more bug reports of a first vulnerability, wherein the one or more bug reports comprise prose that is unstructured data;
generate outputs in response to the input data being applied to the prediction engine, the output data comprising two or more scores including a value for a first score and a value for a second score, the first score representing a likelihood of an exploit being developed for the first vulnerability and the second score representing a likelihood the first vulnerability will be attacked using said exploit; and
triage the first vulnerability with respect to other vulnerabilities using the two or more scores.

14. The computing apparatus of claim 13, wherein, when executed by the processor, stored instructions further configure the apparatus to:
generate, as part of the output data resulting from applying the input data being applied to the prediction engine, a third score representing a likelihood the first vulnerability will become a common vulnerability and exposure (CVE); and
triage the first vulnerability with respect to other vulnerabilities using the first score, the second score, and the third score.

15. The computing apparatus of claim 13, wherein, when executed by the processor, stored instructions further configure the apparatus to:
signal the two or more scores to a user;
receive user feedback regarding the two or more scores; and
perform reinforcement learning based on the received user feedback to update the prediction engine.

16. The computing apparatus of claim 13, wherein:
the prediction engine is trained to classify the first vulnerability based on similarities of the first vulnerability to training vulnerabilities, wherein a set of training data used to train the prediction engine comprises training bug reports and the training vulnerabilities, and, in the set of training data, each of the training vulnerabilities being associated with respective of the training bug reports.

17. The computing apparatus of claim 13, wherein the prediction engine comprises one or more machine learning (ML) methods, the one or more ML methods selected from the group consisting of: a transformer neural network, a natural language processing method, a named entity recognition keyword extraction method, a text classification neural network, and a tokenization neural network.

18. The computing apparatus of claim 13, wherein:
in addition to the unstructured data of the one or more bug reports, the input data further comprises structured data;
the prediction engine generates first predictive information by applying the structured data to a first machine learning (ML) method;
the prediction engine generates second predictive information by applying the unstructured data to a second ML method comprising a transformer neural network; and
the two or more scores are generated based on the first predictive information and the second predictive information.

19. The computing apparatus of claim 13, wherein
the prediction engine comprises a first ML method that generates the first score;
the prediction engine comprises a second ML method that generates the second score; and
the second ML method uses the first score as an input to generate an output comprising the second score.

20. The computing apparatus of claim 13, wherein, when executed by the processor, stored instructions further configure the apparatus to:
apply another input data to the prediction engine, the another input data comprising another bug report of a second vulnerability, and in response generating the output data comprising another two or more scores including another value of the first score and another value of the second score; and
triage the second vulnerability with respect to the first vulnerability using the two or more scores and the another two or more scores, such that the second score serves a primary role and the first score serves a secondary role in determining an order in which the second vulnerability is triaged with respect to the first vulnerability.
